(19) United States
(12) Patent Application Publication
(10) Pub. No.: US 2010/0124788 A1
(43) Pub. Date: May 20, 2010

(54) METHOD FOR HIGH SPATIAL RESOLUTION EXAMINATION OF A SAMPLE STRUCTURE LABELED WITH A SUBSTANCE

(75) Inventor: Jochen Sieber, Mannheim (DE)

Correspondence Address: DARBY & DARBY P.C., P.O. BOX 770, Church Street Station, New York, NY, 10008-0770, US

(73) Assignee: LEICA MICROSYSTEMS CMS GMBH, Wetzlar (DE)

(21) Appl. No.: 12/620,107

(22) Filed: Nov. 17, 2009

(30) Foreign Application Priority Data
Nov. 18, 2008 (DE) 10 2008 058 088.0

(51) Int. Cl. G01N 21/76

(52) U.S. Cl. 436/172

(57) ABSTRACT

A method for high spatial resolution examination of a sample structure includes providing a biological structure as the sample structure with a substance capable of being converted from a first state to a second state. The first and second states of the substance differ in at least one photophysical property. The sample structure is labeled by binding a suitable protein tag including a fluorogen activating protein (FAP) to the sample structure or by expressing the protein tag and the sample structure together as a fusion protein. Then the protein tag is bound to the substance.

### CROSS REFERENCE TO PRIOR APPLICATIONS

Priority is claimed to German Patent Application No. DE 10 2008 058 088.0, filed on Nov. 18, 2008, the entire disclosure of which is hereby incorporated by reference herein.

### FIELD

The present invention relates to a method for high spatial resolution examination of a sample structure labeled with a substance.

### BACKGROUND

Methods of high spatial resolution examination are described, for example, in German Patent Application No. DE 10 2006 045 607 A1, which describes that the protein can be labeled by binding a ligand complex that includes the fluorescent substance to an enzyme using an enzymatic reaction in the cell. In this process, the enzyme and the protein to be examined are expressed together as a fusion protein.

The photophysical property may be, for example, the property of absorbing light, or of returning from the excited state to the ground state, or, alternatively, it would be possible to consider the cross-section for the forbidden transition to the triplet state, etc.

In the method described in DE 10 2006 045 607 A1, for example, a genetically modified hydrolase protein in which the catalytic base has been replaced with a phenylalanine residue is used as the enzyme. A dye may be coupled to this enzyme via a linker.

This method is problematic because, on the whole, it is ultimately limited in its application due to technical limitations (e.g., the signal of a non-specific background color). It cannot satisfy all the requirements of different examination techniques.

FAPs (fluorogen activating proteins) are described, for example, in International Publication Nos. WO 2004/025268 A2 and WO 2008/092041 A2. These proteins are characterized by their interaction with fluorogens such as, for example, thiazole orange (TO) and malachite green (MG). This interaction, which is used for producing fluorescent effects, is also described in the journal “Nature Biotechnology”, vol. 26, no. 2, February 2008, pp. 235-240.

### SUMMARY

In an embodiment, the present invention provides a method for high spatial resolution examination of a sample structure. A biological structure as the sample structure is provided with a substance capable of being converted from a first state to a second state. The first and second states of the substance differ in at least one photophysical property. The sample structure is labeled by binding a suitable protein tag including a fluorogen activating protein (FAP) to the sample structure or by expressing the protein tag and the sample structure together as a fusion protein. The protein tag is then bound to the substance

### BRIEF DESCRIPTION OF THE DRAWINGS

The teaching of the present invention may be advantageously embodied and refined in various ways. In this regard, reference is made to the following description of exemplary embodiments of the invention which makes reference to the drawing. In conjunction with the explanation of the exemplary embodiments of the present invention with reference to the drawing, an explanation is also given of generally preferred embodiments and refinements of the teaching. In the drawings:

FIG. 1 is a schematic view of an exemplary embodiment of a binding process between the substance and the tag. The upper portion of FIG. 1 represents a covalent bond, while the lower portion of FIG. 1 illustrates a non-covalent bond between the tag and the structure.

FIG. 2 is a schematic view of another exemplary embodiment of a binding process between the substance and the tag. The upper portion of FIG. 2 again represents a covalent bond, while the lower portion of FIG. 2 shows a non-covalent bond between the tag and the structure.

### DETAILED DESCRIPTION

According to an embodiment, the present invention provides a method for high spatial resolution examination of a sample structure labeled with a substance whereby a biological structure is used as the structure labeled with the substance, the substance is capable of being converted from a first state to a second state, the first and second states differ from one another in at least one photophysical property, and the labeling of the structure is accomplished by first binding a suitable protein tag to the structure, or by expressing the tag and the structure together as a fusion protein, and by the tag then binding the substance.

In an embodiment, the present invention provides a method that can facilitate further alternative applications for examination with high spatial resolution quality, beyond the known applications.

In an embodiment, a method for high spatial resolution examination of a sample structure labeled with a substance is provided where the tag contains a FAP (fluorogen activating protein).

In accordance with an embodiment of the present invention, it was found, first of all, that an advantage of the method is achieved in a surprisingly simple manner through suitable selection of the tag. Also, in accordance with an embodiment of the present invention, it was discovered that the use of an FAP offers special advantages for various further examination methods. In particular, the method of an embodiment of the present invention allows nearly background-free, high-resolution examination of the labeled structure in a living cell.

Thus, in an embodiment, the present invention provides a method which facilitates further alternative applications for examination with high spatial resolution quality, beyond the known applications.

Specifically, the first state may be a non-fluorescent state and the second state may be a fluorescent state. The interaction of the substance with the tag then causes a transition from the first state to the second state.

In a further advantageous embodiment of the method, the substance may be convertible or switchable from the first state to the second state only when it is bound to the FAP. Thus, it is possible that, specifically, only those particles of the substance which are actually coupled to the protein to be labeled may be converted or switched to the second state. Other substances which may be introduced into the cell do not “disturb” the representation of the structure, for example, by unwanted light emission.

Alternatively, the substance may be convertible or switchable from the first state to the second state only when it is not bound to the FAP.

Depending on the particular application, the bond between the tag and the structure may be a covalent bond. Alternatively, the bond may be a non-covalent bond. Here too, consideration must be given to the particular application. Advantageously, the non-covalent nature of the bond between the substance and the tag may result in that a particle of the substance that is already coupled to the tag may dissociate from the tag and form a new bond with a different tag and/or that another particle of the substance may form a new bond with the original tag.

Advantageously, the bond may have an affinity which is adapted to the particular application. Bleaching is a frequent problem in high-resolution examination techniques. Therefore, long-term observations are mostly not possible because a particle of the substance that has already been bleached can no longer be used to produce fluorescence. Therefore, a molecule of the substance that has been bleached while bound to the FAP may advantageously be replaced with an unbleached molecule of the substance. The affinity may advantageously be adapted in such a way that an optimal replacement rate is achieved for the substance on the FAP in each particular case. A relatively low affinity may be very advantageous here because it allows for faster replacement of bleached molecules with unbleached molecules. Thus, long-term imaging can also be performed using methods which have a greater bleaching effect. The problem of bleaching is thereby significantly reduced. In an embodiment, in which the substance would only fluoresce when bound to the tag, a high background concentration in the sample would be of no importance because no signal would emanate therefrom.

Specifically, the tag may include a portion that binds the structure and a portion that binds the substance. Both portions may be specialized for their respective functions.

Moreover, advantageously, the portion that binds the structure may bind non-covalently to the portion that binds the substance.

Depending on the particular application and requirements, at least one adapter protein may be provided between the portion that binds the structure and the portion that binds the substance. The number of adapter proteins used is to be selected depending on the particular application.

Also, advantageously, one or more photophysical properties of the substance may be controllable by providing or modifying preferably local environmental conditions, such as the bond or the type of bond to the FAP. Such a property may be one that can be used for high-resolution purposes. This makes it possible to obtain exactly the desired properties for the substance that are important for the high-resolution examination method. This allows for a significant improvement of the results obtained. In particular, the convertibility of the substance from one state to another may be controllable.

In another specific embodiment of the method, the substance may be selected or adapted according to the examination technique used or depending on a property of the examination technique used. It is not only the type of substance itself that may be selected or adapted. It is also possible to select or adapt a combination of different substances to improve the examination results.

Substance properties that are important for a particular examination and may be considered include the readiness to transition to the triplet state, a dark state, or the presence of a large cross-section for stimulated emission, or the capability of being photoactivated.

Furthermore, alternatively or additionally, the type of FAP may be selected or adapted according to the examination technique used or depending on a property of the examination technique used.

Particularly advantageously, both the FAPs and the particular fluorescent substance may be optimized for the property that is important for the particular high-resolution examination method so as to thereby obtain better results. In this connection, it is possible to optimize the labeling for the examination technique used. As for the FAP, in particular, this can be easily achieved through present-day molecular biology and available screening methods. The FAP can be modified in such a way that the binding behavior, the affinity, and possibly also the photophysical properties of the substance used are optimized for the particular application.

The combination that is suitable for a particular application can be readily obtained by using different substances in conjunction with a given FAP, or by using a given substance in conjunction with different FAPs.

The method may be used particularly advantageously in the field of STED (stimulated emission depletion) microscopy. Alternatively or additionally, the method may be used in the field of RESOLFT (reversible saturable optical fluorescence transitions), GSD (ground state depletion), DSO (Dynamic Saturation Optical), or SSI (Saturated Structured Illumination) microscopy. Ultimately, the method in an embodiment of the present invention enables FAP nanoscopy in living cells.

By suitably combining a fluorescent substance with a FAP, it becomes possible even for structures in living cells to be labeled with fluorophores or fluorescent dyes which have the properties that are suitable for the particular technique, such as a high or low tendency to transition to the triplet state, a low level of bleaching, a large cross-section for stimulated emission, etc.

One advantage of the FAP technology is that because of the binding of the substance, fluorophore or fluorogen, to the FAP, the properties of the substance, fluorophore or fluorogen, may be changed. For example, initially, the substance may not fluoresce or emit light, but may do so after forming a bond with the FAP.

With a view to reducing the bleaching problem, it is beneficial that the bond between the substance and the FAP is non-covalent. This allows the substance, fluorophore or fluorogen, to dissociate from the binding site and to form a new bond. Thus, if the substance has previously been bleached, it may be replaced with an unbleached substance. This is a clear advantage which enables long-term imaging to be performed also using methods which have a greater bleaching effect. Therefore, it may be convenient to use substance/FAP combinations of relatively low affinity to thereby reduce the problem of bleaching.

Substance/FAP combinations are used to label structures for purposes of super-resolution microscopy, where specific properties of the substance are used to achieve ultra-high resolution. Also, specific substance properties that are decisive for the corresponding super-resolution techniques may be selectively optimized and it is possible to control the binding to a correspondingly selected FAP.

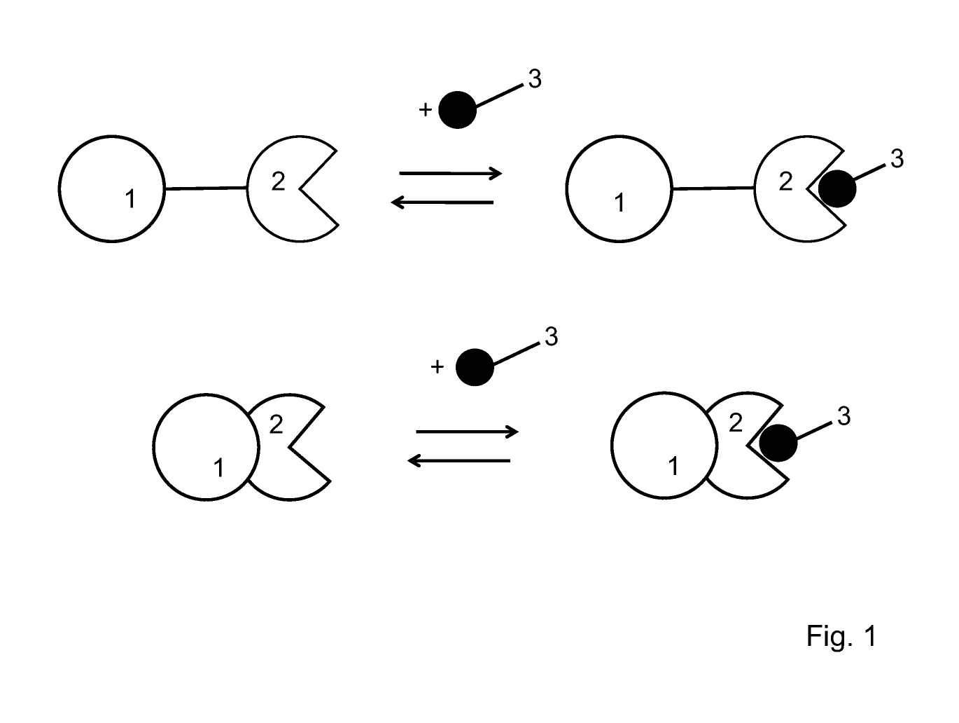

In a schematic representation, FIG. 1 shows two different types of bonds between a structure 1 and a tag 2. The bond between structure 1 and a tag 2 shown in the upper portion of FIG. 1 is a covalent one. The lower portion of FIG. 1 illustrates a non-covalent bond between tag 2 and structure 1.

Also shown in FIG. 1 is the addition of a labeling substance 3 to tag 2. The double arrow between the state in which substance 3 is not bound and that in which substance 3 is bound indicates that, once substance 3 has bound to tag 2, it may dissociate from tag 2 again.

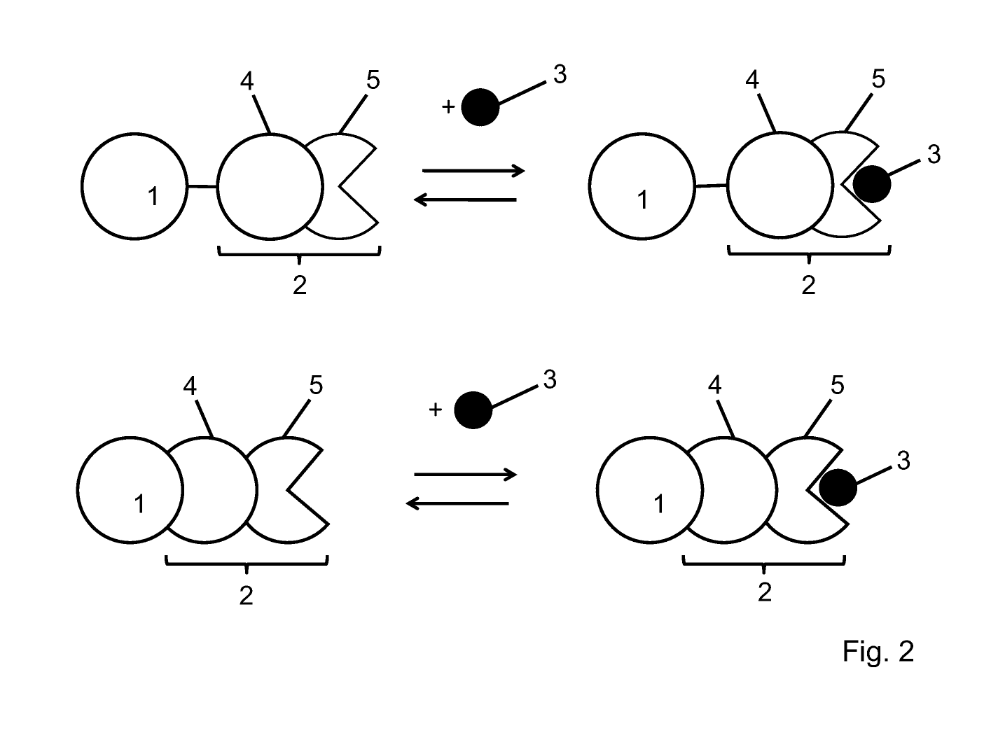

FIG. 2 is similar to FIG. 1, the upper portion showing a covalent bond between structure 1 and tag 2 and the lower portion depicting a non-covalent bond between structure 1 and tag 2. The two portions further illustrate the addition of a labeling substance 3 to tag 2.

The exemplary embodiment shown in FIG. 2 differs from that of FIG. 1 in that tag 2 includes a first portion 4 that binds structure 1 and a second portion 5 that binds substance 3.

Portion 4 is non-covalently bound to portion 5. At least one adapter protein may be bound between the first portion 4, which binds structure 1, and the second portion 5, which binds substance 3.

Finally, it should be emphasized that the exemplary embodiments discussed above are merely intended to illustrate the present invention, but not to limit it to such embodiments.

### LIST OF REFERENCE NUMERALS

1 structure
2 tag
3 substance
4 first portion
5 second portion

What is claimed is:

1. A method for high spatial resolution examination of a sample structure, comprising:
providing a biological structure as the sample structure with a substance capable of being converted from a first state to a second state, wherein the first and second states differ in at least one photophysical property;
labeling the sample structure by binding a suitable protein tag including a fluorogen activating protein (FAP) to the sample structure or by expressing the protein tag and the sample structure together as a fusion protein; and then
binding the protein tag to the substance.

2. The method according to claim 1, wherein the first state is a non-fluorescent state and the second state is a fluorescent state.

3. The method according to claim 1, wherein the substance is capable of being converted from the first state to the second state only when the substance is bound to the FAP.

4. The method according to claim 1, wherein the substance is capable of being converted from the first state to the second state only when the substance is not bound to the FAP.

5. The method according to claim 1, wherein the binding of the protein tag to the sample structure is covalent binding.

6. The method according to claim 1, wherein the binding of the protein tag to the sample structure is non-covalent binding.

7. The method according to claim 1, further comprising bleaching the substance while it is bound to the FAP and replacing a molecule of the substance with an unbleached molecule of the substance.

8. The method according to claim 1, wherein the protein tag includes a first portion that binds to the sample structure and a second portion that binds to the substance.

9. The method according to claim 8, wherein the first portion binds non-covalently to the second portion.

10. The method according to 8, wherein at least one adapter protein is provided between the first portion and the second portion.

11. The method according to claim 1, wherein at least one of the photophysical properties of the substance is controllable by local environmental conditions.

12. The method according to claim 11, further comprising modifying at least one of the photophysical properties of the substance through the binding with the protein tag.

13. The method according to claim 12, wherein the modifying of at least one of the photophysical properties of the substance is based on a binding type with the FAP.

14. The method according to claim 1, further comprising selecting a type of the FAP based on an examination technique or a property of the examination technique.

15. The method according to claim 1, wherein the high spatial resolution examination is performed in accordance with stimulated emission depletion (STED) microscopy.

16. The method according to claim 1, wherein the high spatial resolution examination is performed in accordance with at least one of reversible saturable optical fluorescence transitions, ground state depletion, dynamic saturation optical and saturated structured illumination microscopy.
